(19) United States
(12) Patent Application Publication
(10) Pub. No.: US 2001/0040150 A1
(43) Pub. Date: Nov. 15, 2001

(54) Glass substrate for information-recording medium and manufacturing method of the glass substrate

(75) Inventor: Hisanori Suzuki, Kofu-shi (JP)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Hoya Corporation

(21) Appl. No.: 09/905,751

(22) Filed: Jul. 13, 2001

Related U.S. Application Data
(62) Division of application No. 09/182,389, filed on Oct. 29, 1998.

(30) Foreign Application Priority Data
Oct. 30, 1997 (JP) 298887/1997

(51) Int. Cl. B23K 26/36; B32B 1/00

(52) U.S. Cl. 219/121.69; 428/141; 428/64.2

(57) ABSTRACT

A glass substrate for a highly reliable information-recording medium in which stiction is reduced because of a small diameter of each protuberance, the CSS durability is good, and a head is prevented from being damaged, is provided. A method capable of stably manufacturing such a glass substrate for a highly reliable information-recording medium with a good controllability, is also provided. In a method of making protuberances 1a by irradiation to a glass substrate 1 with a laser light, a glass substrate having a coefficient of thermal expansion of 75×10⁻⁷/° C. or more is used as the glass substrate 1.

### REFERENCE TO RELATED APPLICATION

This application claims the priority right under 35 U.S.C. 119, of Japanese Patent Application No. Hei 09-298887 filed on Oct. 30, 1997, the entire disclosure of which is incorporated herein by reference.

### BACKGROUND OF THE INVENTION

(i) Field of the Invention

The present invention relates to a glass substrate for an information-recording medium and a manufacturing method of the glass substrate, particularly to a glass substrate for a magnetic disc showing a good CSS (contact start and stop) characteristic and a manufacturing method of the glass substrate.

(ii) Description of the Related Art

In magnetic-disc devices, a mechanism called CSS (contact start and stop) system is generally used, in which a magnetic head is brought into contact with a surface of a stationary magnetic disc and a rotation of the magnetic disc is started and stopped in the contact state with the magnetic head.

In a surface of such a magnetic disc used in the CSS system, properly minute roughness called “texture” is made for the purpose of preventing stiction (sticking), which arises when a rotation of the magnetic disc is started or stopped, and reducing friction.

Such texture is made in the whole or a part of a primary surface of the disc. In case of texture made in a part (CSS zone), a magnetic head moves to the CSS zone, at which the texture is made, at a proper time in a CSS operation. The magnetic head also moves to the CSS zone in such a case as the power supply is cut when the disc is rotating. In case of partially made texture in this manner, the other part of the disc surface can be kept smooth like a mirror surface and so the running of a magnetic head with low floating becomes possible. For this reason, partially made texture is suitable for a highly dense record of a magnetic-disc device.

As the substrate of such a magnetic disc, a so-called aluminum substrate in which a substrate of an Al—Mg alloy is plated with Ni-P is hitherto used. But such an aluminum substrate is not enough to meet recent requirements of a more highly dense record and the running of a magnetic head with lower floating. For this reason, glass substrates superior in smoothness, rigidity, impact resistance, thermal resistance and so on are now remarked.

In case of glass substrates, techniques for making texture become more important because their surfaces can be smooth. Lately, a method of irradiation with a laser light is proposed for making texture on a glass substrate from the viewpoint of controllability of shapes of protuberances, and stability and cost in manufacturing.

Japanese Patent Unexamined Publication No. Hei 7-182655 describes a method for making texture particularly on a brittle material such as glass. It discloses a fact that texture-processing is possible by controlling the fluence of a radiant energy in a proper order less than the thermal impact limit of a brittle material such as glass. It also discloses a fact that almost the whole protuberances protrude beyond the nominal surface in case of a glass (chemically strengthened glass) having a surface with compressive stress and so it is useful for decreasing stiction of a data-storing disc. By this texture-processing method of the Japanese Patent Unexamined Publication No. Hei 7-182655 using a laser light, texture can be made on a glass substrate at a low cost with a good controllability because it uses CO₂ laser, which is widely used. There is also described that it is easy to make texture only at the CSS zone.

It is, however, difficult to focus the beams because of the long wavelength of 10.6 μm of the CO₂ laser used for making texture on a glass substrate, and so the diameter of each protuberance becomes large. Such large-diameter protuberances bring about an increase in contact area between a magnetic-disc substrate and a magnetic head. There arises a problem that stiction becomes large (it is easy to stick) due to meniscus.

### SUMMARY OF THE INVENTION

It is an object of the present invention to provide a glass substrate for a highly reliable information-recording medium in which stiction is reduced by decreasing the diameter of each protuberance, and a manufacturing method of the glass substrate.

According to the present invention, a glass substrate for an information-recording medium, in a surface of which substrate protuberances are made at a predetermined area by irradiation with a laser light, has a coefficient of thermal expansion of 75×10⁻⁷/° C. or more. By this feature, stiction is reduced because the diameter of each protuberance can be relatively small. The principle will be described hereinafter.

CO₂ laser used for making protuberances on a glass substrate of the present invention has the long wavelength of 10.6 μm, and so making its beam diameter small is difficult in comparison with ultraviolet or visible lasers generally used for aluminum substrates. Besides, the mechanism of formation of the protuberances on the glass substrate is different from that on an aluminum substrate. In case of glass substrate, portions irradiated with a laser light expand by heat and their shapes are fixed to form protuberances when the substrate temperature exceeds its glass transition point. In case of a glass substrate treated by ion exchange, residual compressive stresses are present in its surface, so the stresses of portions irradiated with a laser light are relieved by heat and the compressive stresses of the other portions are relieved at the portions irradiated with the laser light to form protuberances. Each protuberance is therefore made only at the central portion of each laser beam at which the energies of the laser light are concentrated. The diameter of the protuberance is reputed to be ⅓ of the beam diameter in general. When the beam diameter is fixed the diameter of a protuberance only depends on the height of the protuberance. The diameter of the protuberance can not be varied in the same height even by varying a parameter such as pulse energy. Because the radius of curvature of the tip portion of the protuberance depends on the height and the diameter of the protuberance, the beam diameter had to be made small for decreasing the radius of curvature of the tip portion.

After eagerly studying, the present inventor found a fact that the formation of the protuberance (the radius of curvature of the tip portion) greatly depends on the coefficient of thermal expansion of the glass, and so came to complete the present invention. That is, it was found that the diameter of each protuberance can be made small and stiction can be effectively reduced by using a glass substrate having a coefficient of thermal expansion of a certain value (75×10⁻⁷/° C.) or more. In the portion which was irradiated with a laser beam and expanded by heat, a portion the temperature of which rose to the glass transition point holds its shape even after it is cooled, but a portion the temperature of which did not rise to the glass transition point shrinks as a reaction of expansion when it is cooled. In case of a large coefficient of thermal expansion, the shrinkage of the latter portion becomes large. As a result, the diameter of the protuberance thus formed becomes small and a desirable shape of the protuberance can be obtained.

The coefficient of thermal expansion of a glass substrate according to the present invention is not less than 75×10⁻⁷/° C., preferably not less than 90×10⁻⁷/° C., more preferably not less than 95×10⁻⁷/° C. for reducing stiction. The coefficient of thermal expansion of the glass substrate is desirably not more than 130×10⁻⁷/° C. This is because a clamp generally used in a magnetic-disc device is mostly made of stainless steel. A high-performance magnetic disc can be obtained by matching the coefficient of thermal expansion of the glass substrate with the coefficient of thermal expansion of the clamp.

A glass substrate according to the present invention is desirably made of an oxide glass containing transition-metal oxide. This is because such an oxide glass can be chemically treated for strengthening in general and so a glass substrate good in impact resistance and anti-vibration characteristic can be obtained for an information-recording medium. Examples of the glass material are aluminosilicate glass, soda-lime glass, soda-aluminosilicate glass, aluminoborosilicate glass, and borosilicate glass. Among them, aluminosilicate glass is most desirable because it is superior in impact resistance and anti-vibration characteristic.

An aluminosilicate glass used in the present invention may contain SiO₂: 62-75 wt. %, Al₂O₃: 5-15 wt. %, Li₂O: 4-10 wt. %, Na₂O: 4-12 wt. %, and ZrO₂: 5.5-15 wt. % as essential components, in which the ratio in weight of Na₂O/ZrO₂ is 0.5-2.0 and the ratio in weight of Al₂O₃/ZrO₂ is 0.4-2.5. Another aluminosilicate glass used in the present invention may contain TiO₂: 5-30 mol %, Al₂O₃: 0-15 mol %, SiO₂: 35-65 mol %, CaO: 1-45 mol %, MgO+CaO: 10-45 mol %, and Li₂O+Na₂O: 3-30 mol %. In particular, the latter aluminosilicate glass is more desirable because it has a high Young's modulus and so brings about a highly dense record by a high-speed rotation in recent years.

The height of each protuberance is desirably 20-300 A. If the height of each protuberance is less than 20 Å, a magnetic head may stick to a magnetic disc. If the height of each protuberance is more than 300 Å, the running of a magnetic head with low floating can not be realized. The diameter of each protuberance is desirably 1-6 μm. If the diameter of each protuberance is less than 1 μm, it is easy to damage a protuberance. If the diameter of each protuberance is more than 6 μm, stiction becomes large. In case of protuberances made only at the CSS zone of a magnetic disc, the surface condition of the data zone of the magnetic disc can be kept very smooth and so the running of a magnetic head with low floating becomes possible, as a result, a highly dense record and its reproduction can be realized.

In a manufacturing method of a glass substrate for an information-recording medium according to the present invention, a predetermined area of a surface of a disclike glass substrate having a coefficient of thermal expansion of 75×10⁻⁷/° C. or more is irradiated with a laser light to make protuberances. By using a glass substrate having a specified coefficient of thermal expansion in this manner, the diameter of each protuberance can be made small and stiction can be effectively reduced, and so a glass substrate for a highly reliable information-recording medium can be stably and easily manufactured with a good controllability.

In a manufacturing method according to the present invention, CO₂ laser may be used as a laser light for making protuberances, and thereby a decrease in cost of manufacture can be realized. A glass substrate is desirably irradiated with a laser light after it is chemically strengthened.

### BRIEF DESCRIPTION OF THE DRAWINGS

FIG. 1 is a cross-sectional view of a magnetic disc comprising a glass substrate according to an embodiment of the present invention; and

FIG. 2 is a schematic illustration showing a laser texture apparatus used in the embodiment of the present invention.

### DETAILED DESCRIPTION OF THE PREFERRED EMBODIMENT

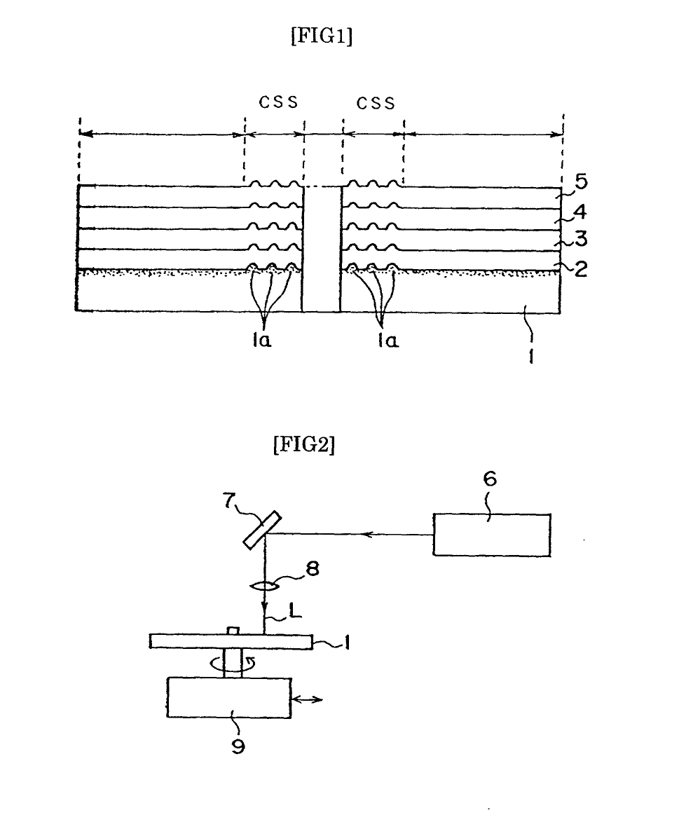

Next, an embodiment of the present invention will be described with reference to a drawing. FIG. 1 shows a cross section of a magnetic disc comprising a glass substrate according to an embodiment of the present invention. This magnetic disc comprises a disclike glass substrate 1 in which a surface layer is formed into a compressive-stress layer and protuberances 1a are made at the CSS zone by irradiation with a laser light. An underlying layer 2, a magnetic layer 3, a protection layer 4 and a lubricant layer 5 are formed in order on the glass substrate 1.

The glass substrate 1 can be made of an aluminosilicate glass containing SiO₂: 62-75 wt. %, Al₂O₃: 5-15 wt. %, Li₂O: 4-10 wt. %, Na₂O: 4-12 wt. %, and ZrO₂: 5.5-15 wt. % as essential components, in which the ratio in weight of Na₂O/ZrO₂ is 0.5-2.0 and the ratio in weight of Al₂O₃/ZrO₂ is 0.4-2.5, or an aluminosilicate glass containing TiO₂: 5-30 mol %, Al₂O₃: 0-15 mol %, SiO₂: 35-65 mol %, CaO: 1-45 mol %, MgO+CaO: 10-45 mol %, and Li₂O+Na₂O: 3-30 mol %. The coefficient of thermal expansion of this glass substrate 1 is not less than 75×10⁻⁷/° C. and not more than 130×10⁻⁷/° C.

The above magnetic disc is manufactured using this glass substrate 1 by the following method. First, the glass substrate 1 having a composition as described above is chemically strengthened by a low-temperature ion exchange method. The glass substrate 1 is then irradiated with a laser light to make protuberances 1a. The irradiation of the glass substrate 1 is performed with a laser texture apparatus schematically shown in FIG. 2. This laser texture apparatus includes a CO₂ pulse laser 6 as light source for laser processing. A mirror 7 and a condensing lens 8 are disposed so that laser beams L of the wavelength of 10.6 μm emitted from the CO₂ pulse laser 6 are just focussed on a predetermined position of a surface of the glass substrate 1. The glass substrate 1 on which protuberances 1a are to be made is mounted on a drive motor 9 which is provided with a rotation mechanism for rotating the glass substrate 1 and a moving mechanism for radially moving the glass substrate 1. While the glass substrate 1 mounted on the drive motor 9 is rotated at a predetermined speed and moved radially, a spot-like laser light of the pulse duration of 1-30 μsec and the power of 80-250 mW is applied to a surface of the glass substrate 1 to make a large number of protuberances 1a at proper intervals in the CSS zone.

Next, an underlying layer 2, a magnetic layer 3 and a protection layer 4 are formed in order on the surface of the glass substrate 1 with a sputtering device. A lubricant layer 5 is then formed on the surface of the protection layer 4 to complete a magnetic disc.

The material of the underlying layer 2 of the magnetic disc is selected in accordance with the magnetic layer 3. The underlying layer 2 may consist of at least one of non-magnetic metals such as Cr, Mo, Ta, Ti, W, V, B, Al and Ni. In case of the magnetic layer 3 containing Co as the main component, the underlying layer 2 is desirably made of only Cr or a Cr alloy from the viewpoint of improving magnetic characteristics. The underlying layer 2 is not limited to a single layer but may have a multilayer structure in which the same kind or different kinds of layers are piled. For example, it may have a structure of Cr/Cr, Cr/CrMo, Cr/CrV, CrV/CrV, Al/Cr/CrMo, Al/Cr/Cr, Al/Cr/CrV, Al/CrV/CrV, or the like.

There is no particular limitation in the material of the magnetic layer 3 of the magnetic disc. For example, the magnetic layer 3 may be made of a magnetic material which contains Co as the main component. Examples of such a material are CoPt, CoCr, CoNi, CoNiCr, CoCrTa, CoPtCr, CoNiPt, CoNiCrPt, CoNiCrTa, CoCrTaPt, and CoCrTaPtSiO. The magnetic layer 3 may have a multilayer structure in which a nonmagnetic layer (for example, Cr, CrMo, CrV or the like) is interposed between each pair of magnetic layers for reducing noise. The magnetic layer 3 may be made of a ferrite or a material of iron-rare earth. The magnetic layer 3 may be a granular magnetic layer in which magnetic particles such as Fe, Co, FeCo and CoNiPt are dispersed in a non-magnetic layer made of SiO₂, BN or the like. The magnetic layer 3 may be for either recording method of in-surface magnetization type (an in-plane type, a longitudinal type) and normal magnetization type (a perpendicular type).

There is no particular limitation in the protection layer 4 of the magnetic disc. Examples of the protection layer 4 are a Cr layer, a Cr alloy layer, a carbon layer, a zirconia layer, and a silica layer. The protection layer 4 can be formed successively from the underlying layer 2 and the magnetic layer 3 in an in-line sputtering device. The protection layer 4 may be a single layer or may have a multilayer structure in which the same kind or different kinds of layers are piled.

There is no particular limitation in the lubricant layer 5 of the magnetic disc. In certain cases, the lubricant layer 5 may be omitted. The lubricant layer 5 is formed, for example, in the manner that perfluoro-polyether is diluted with a solvent such as Freon, and the obtained solution is applied to the surface of the protection layer 4 by a dipping method, a spin-coat method, a spraying method or the like, and then a thermal treatment is performed if need be.

Next, examples of the above manufacturing method of a magnetic disc will be described.

### EXAMPLE 1

(1) Step of Preparing Glass Substrate

An aluminosilicate glass substrate was processed into a disc shape which has the outside diameter of 65 mmφ, the central bore diameter of 20 mmφ, and the thickness of 0.65 mm. Both primary surfaces and the inside and outside end surfaces of the substrate were precisely polished to obtain Rmax of 0.5 nm or less and Ra of 0.3 nm or less. The glass substrate which had been precisely polished was purified with ultrasonic for 5 minutes in each of a pure water and more than 99.9% isopropyl alcohol (IPA) in a purifier, and then left in vapor of IPA for 1.5 minutes, and then dried. As the glass substrate, an aluminosilicate glass containing TiO₂: 5-30 mol %, Al₂O₃: 0-15 mol %, SiO₂: 35-65 mol %, CaO: 1-45 mol %, MgO+CaO: 10-45 mol %, and Li₂O+Na₂O: 3-30 mol % and having the coefficient of thermal expansion of 100×10⁻⁷/° C. was used.

(2) Step of Chemically Strengthening Glass

The above glass substrate was chemically strengthened as follows. A chemically strengthening solution in which potassium nitrate (60%) and sodium nitrate (40%) were mixed was heated to 400° C., and the glass substrate having been purified and preheated to 300° C. was dipped in the solution for about 3 hours. The glass substrate having been chemically strengthened was dipped in a water bath at 20° C. rapidly to cool. The glass substrate was maintained in the bath for about 10 minutes. The glass substrate having been rapidly cooled was dipped in sulfuric acid at about 40° C. and purified with ultrasonic.

(3) Step of Making Protuberances by Irradiation with Laser Light

Next, protuberances were made only at the CSS zones of both surfaces of the above chemically strengthened glass substrate with the laser texture apparatus schematically shown in FIG. 2. That is, while the glass substrate mounted on the drive motor was rotated at a rotational speed of 120 r.p.m. and radially moved at a speed of 9.6 mm/min, the glass substrate was irradiated with a laser light of the power of 200 mW, the pulse duration of 20 μsec, the laser spot diameter of 50 μm, and the interval of 80 μm between neighboring applied positions by the laser spot. The laser light was applied so that the texture formation area is at the radial range of 13.0-16.0 mm on the disc and the arrangement of the protuberances of the texture is on a tetragonal lattice. After then, the glass substrate was purified with ultrasonic for 5 minutes in each of a pure water and more than 99.9% isopropyl alcohol (IPA) in a purifier, and then left in vapor of IPA for 1.5 minutes, and then dried. The glass substrate on which the protuberances were made only at the CSS zones was thereby obtained.

(4) Step of Forming Layers With an in-line sputtering device, an underlying layer of Al, an underlying layer of Cr, an underlying layer of CrMo, a magnetic layer of CoCrTaPt, and a protection layer of carbon were formed in order on either surface of the glass substrate obtained through the above steps. The glass substrate was then removed from the in-line sputtering device, and a lubricant layer of liquid perfluoro-polyether was formed on the surface of each protection layer by a dipping method. A magnetic disc was thereby obtained.

### EXAMPLE 2

A magnetic disc was obtained in the same manner as that of the example 1 but an aluminosilicate glass containing SiO₂: 63.0%, Al₂O₃: 14.0%, Li₂O: 6.0%, Na₂O: 10.0%, and ZrO₂: 7.0% in weight and having the coefficient of thermal expansion of 91×10⁻⁷/° C. was used as a glass substrate.

### EXAMPLE 3

A magnetic disc was obtained in the same manner as that of the example 1 but a glass for chemically strengthening which contained SiO₂: 64.0%, Al₂O₃: 8.5%, Na₂O: 8.0%, K₂O: 7.0%, ZnO: 2.7%, Li₂O: 1.0%, BaO: 1.0%, B₂O₃: 2.0%, TiO₂: 1.0%, ZrO₂: 4.5%, and As₂O₃: 0.3% in weight and had the coefficient of thermal expansion of 85×10⁻⁷/° C. was used as a glass substrate.

### EXAMPLE 4

A magnetic disc was obtained in the same manner as that of the example 1 but a glass for chemically strengthening which contained SiO₂: 70.5%, Al₂O₃: 5.0%, MgO: 9.0%, B₂O₃: 2.0%, As₂O₃: 0.5%, and Na₂O: 13.0% in weight and had the coefficient of thermal expansion of 75×10⁻⁷/° C. was used as a glass substrate.

### COMPARATIVE EXAMPLE

A magnetic disc was obtained in the same manner as that of the example 1 but a glass for chemically strengthening which contained SiO₂: 63.0%, Al₂O₃: 4.0%, MgO: 10.0%, K₂O: 16.0%, Li₂O: 2.0%, and B₂O₃: 5.0% in weight and had the coefficient of thermal expansion of 70×10⁻⁷/° C. was used as a glass substrate.

Results

By observing the glass substrates after texture processing, it was confirmed that protuberances each having a round tip were made at constant intervals in any of the examples 1-4 and the comparative example. When the heights and the diameters of the protuberances were measured with a shape measurement apparatus (HD2000 made by Wyko), the mean height of the protuberances was 150 &Ovalhollow; and the diameters of the protuberances were in the range of 5-6 μm in case of the examples 1-4. On the other hand, the mean height of the protuberances was 150 Å and the diameters of the protuberances were in the range of 8-10 μm in case of the comparative example. It was therefore understood that the diameters of the protuberances of the examples 1-4 became small enough in comparison with those of the comparative example. When each of the obtained magnetic discs was subjected to a CSS durability test of a hundred thousand times using a 70% head slider with a load of 3 g, the following results were obtained. In case of the examples 1-4, the friction was small as 0.2 in the beginning of the test and less than 1 even after the test of the hundred thousand times was completed. Stiction (sticking) did not occur, the CSS durability was good, and a magnetic head was not damaged. Contrastingly in case of the comparative example, the friction was large as 0.3 in the beginning of the test and exceeded 1 after the test of the hundred thousand times was completed. Stiction occurred, the CSS durability was bad, and a magnetic head was damaged.

Although the examples of the present invention were described above, the present invention is not limited to the above examples.

Although glasses for chemically strengthening were used for glass substrates by way of example in the above description, the material of a glass substrate of the present invention is not limited to those but may be a crystallization glass or a ceramic.

Although CO₂ laser of the wavelength of 10.6 μm in infrared range is used in the above description, a laser usable in the present invention is not limited to that but any laser, for example, an excimer laser generating a wavelength in ultraviolet range, or a laser utilizing a highly harmonic wave of a YAG laser, may be used if a formation of texture on a glass substrate is possible with it.

Although only glass substrates for magnetic discs are described above, the present invention is also usable for a substrate of a standard disc (bump disc) for correcting a glide tester, or a substrate of an optical disc, for example.

What is claimed is:

1. A glass substrate for an information-recording medium, in a surface of which substrate protuberances are made at a predetermined area by irradiation with a laser light, wherein the coefficient of thermal expansion of said glass substrate is not less than 75×10⁻⁷/° C.

2. A glass substrate for an information-recording medium, in a surface of which substrate protuberances are made at a predetermined area by irradiation with a laser light, wherein the coefficient of thermal expansion of said glass substrate is not less than 90×10⁻⁷/° C.

3. A glass substrate for an information-recording medium, in a surface of which substrate protuberances are made at a predetermined area by irradiation with a laser light, wherein the coefficient of thermal expansion of said glass substrate is not less than 75×10⁻⁷/° C. and not more than 130×10⁻⁷/° C.

4. A glass substrate for an information-recording medium, in a surface of which substrate protuberances are made at a predetermined area by irradiation with a laser light, wherein the coefficient of thermal expansion of said glass substrate is not less than 90×10⁻⁷/° C. and not more than 130×10⁻⁷/° C.

5. A glass substrate for an information-recording medium according to any of claims 1 to 4, wherein said glass substrate is made of an oxide glass containing transition metal oxide:

6. A glass substrate for an information-recording medium according to any of claims 1 to 4, wherein the heights of said protuberances are within the range of 20 to 300 Å and the diameters of said protuberances are within the range of 1 to 6 μm.

7. A glass substrate for an information-recording medium according to any of claims 1 to 4, wherein said protuberances are made only at a CSS zone.

8. A manufacturing method of a glass substrate for an information-recording medium, wherein protuberances are made at a predetermined area of a surface of a glass substrate having a coefficient of thermal expansion of 75×10⁻⁷/° C. or more, by irradiation with a laser light.

9. A manufacturing method of a glass substrate for an information-recording medium according to claim 8, wherein said laser light is CO₂ laser light.

10. A manufacturing method of a glass substrate for an information-recording medium according to claim 8 or 9, wherein said irradiation with said laser light is performed after said glass substrate is chemically strengthened.
